(19) United States
(12) Patent Application Publication
(10) Pub. No.: US 2023/0306082 A1
(43) Pub. Date: Sep. 28, 2023

(54) HARDWARE ACCELERATION OF REINFORCEMENT LEARNING WITHIN NETWORK DEVICES

(71) Applicant: Mellanox Technologies, Ltd., Yokneam (IL)

(72) Inventors: Shridhar Rasal, Pune (IN); Gal Yefet, Haifa (IL)

(21) Appl. No.: 17/700,944

(22) Filed: Mar. 22, 2022

(51) Int. Cl. G06K 9/62; G06F 15/78; H04L 47/24

(52) U.S. Cl. CPC G06K 9/6262; G06F 15/781; G06F 15/7814; H04L 47/24; G06N 20/00

(57) ABSTRACT

A network interface device includes a memory to store configuration values associated with a reinforcement learning (RL) routine and a set of RL-related parameters associated with the RL routine, packet processing circuitry to receive network packets, and accelerator circuitry coupled to the memory and the packet processing circuitry. The accelerator circuitry is to: detect a network packet that includes a particular criterion; and execute the RL routine, using the configuration values and in response to detecting the network packet, to employ observation information derived from or associated with the network packet to perform an RL-related action.

### TECHNICAL FIELD

At least one embodiment pertains to processing resources used to perform and facilitate network communication. For example, at least one embodiment pertains to technology for hardware acceleration of reinforcement learning within network devices.

### BACKGROUND

Network devices (e.g., switches, routers, hubs, end-points, and the like) are being designed with not only a network interface card (NIC), but also significant processing capability in a host processing device, e.g., a central processing unit (CPU), an accelerated processing unit (APU), or the like, which is designed for high data transfer applications and increased throughput. As a result, such host processing devices have been programmed to run software that increases performance, to include software that performs reinforced learning (RL) to improve network tasks. For example, RL is best suited for making cognitive choices, such as decision making, planning, and scheduling. Moreover, RL-based methods do not need supervision, but rather define a particular reward function, which maximize or optimize an attribute, making reinforcement learning a natural choice for networking tasks.

Thus, networking devices can improve various configuration parameters such as bandwidth, throughput, congestion control, and other artificial intelligence (AI)-based learning parameters, by performing an RL algorithm or routine. Performing reinforcement learning within software of the host processing device, however, requires waking up or triggering the software to perform iterations of an RL algorithm or routine, thus at least partially degrading the performance of the network device that the reinforcement learning is designed to improve.

### BRIEF DESCRIPTION OF DRAWINGS

Various embodiments in accordance with the present disclosure will be described with reference to the drawings, in which:

FIG. 1 is a simplified flow diagram of a reinforcement learning (RL) system, in accordance with at least some embodiments;

FIG. 2 is a flow diagram of a State-Action-Reward-State-Action (SARSA) algorithm, an example of a type of RL, in accordance with at least some embodiments;

FIG. 3 is a block diagram of a network device containing a network interface card (NIC) to which is offloaded reinforcement learning, in accordance with at least some embodiments;

FIG. 4 is a flow diagram of method performing reinforcement learning by a NIC, in accordance with at least some embodiments;

FIG. 5A is a flow diagram of a method for offloading reinforcement learning from a host processing device to a NIC, in accordance with at least some embodiments; and

FIG. 5B is a flow diagram of a method for an accelerator of the NIC performing the RL routine or algorithm, in accordance with at least some embodiments.

### DETAILED DESCRIPTION

As described above, each time reinforcement learning (RL) algorithm can be triggered by some change in data packet flow through a network device, so the network device has to wake up and/or trigger software to run on a host processing device to perform one or more iterations of the RL algorithm. Software reacts more slowly, involves latencies, and runs at much slower speeds than hardware, thus performing reinforcement learning within a network device carries challenges in which performance gains are limited by software.

Aspects and embodiments of the present disclosure address the deficiencies of executing reinforcement learning within network devices with software and other challenges by employing a software interface on a host processing device to initiate and program specialized hardware on a network interface card (NIC) (or similar integrated network interface device or system) to perform the reinforcement learning. For example, the host processing device can trigger an interrupt request that causes a context switch in the NIC to perform a different application adapted for reinforcement learning. The host processing device can further send, to the NIC, a configuration file, which when deployed by the NIC, causes accelerator circuitry of the NIC to load configuration data into memory for a set of RL-related parameters and associated formatting data received from the host processing device (some of which may have remained in memory if the application was recently run on the NIC).

In various embodiments, once the NIC has been configured and programmed to execute an RL-based application, the NIC can further detect network packets that include a particular criterion. For example, the particular criterion and include that the network packets are received at a particular port or that include (or are tagged with) a particular identifier. The NIC can then execute the RL algorithm (or RL routine), using configuration values stored in memory and in response to detecting the network packet, to employ observation information derived from or associated with the network packet to perform an RL-related action. This RL-related action, for example, can include updating a configuration value for the RL-related parameter stored in a hardware or software register of the NIC. This configuration value can continue to be updated through iterations of the RL routine until satisfying a target end value, which can be understood as reaching a particular goal of the RL routine.

Only by way of example, this target end value can be (or be associated with) a target of a particular bandwidth, throughput, or some congestion-related variable being optimized by the RL routine. Once this target end value is reached, the host processing device can detect (or be informed by the NIC) of the target end value, after which a context switch can be triggered to another application to be executed by the accelerator circuitry. In various embodiments, reinforcement learning is employed in a variety of use-cases related to networking devices, including but not limited to, congestion control, tuning enhancement, cache eviction and/or memory allocation improvement, resolving performance and power trade-offs, fault prediction, intrusion detection, traffic predictions, and the like.

Advantages of the present disclosure include but are not limited to improving the speed and overall performance of a network device that performs reinforcement learning (RL), such as to improve on one or more functional aspects of the network device, as will be discussed herein. By offloading RL routine performance to accelerator hardware on a NIC or similar device or system, the host processing device avoids latencies and other performance impacts associated with the trigger and executing the RL routine in software. Other advantages will be apparent to those skilled in the art in the features of avoiding line cache misses discussed hereinafter.

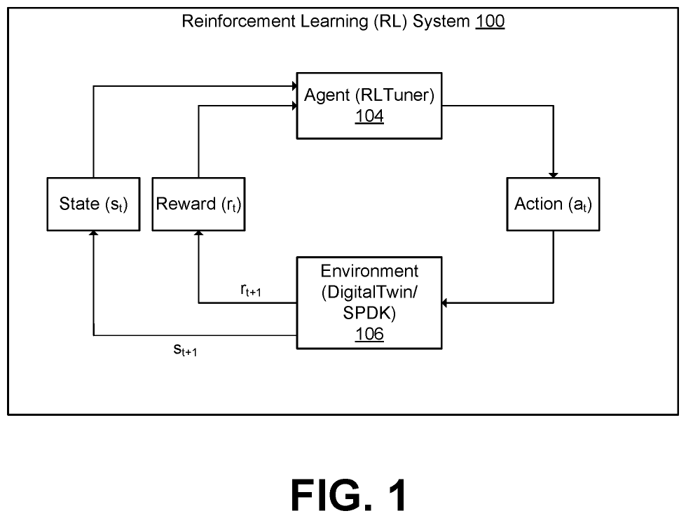

FIG. 1 is a simplified flow diagram of a reinforcement learning (RL) system 100, in accordance with at least some embodiments, which can be understood to be performing an RL routine or algorithm. The RL routine or algorithm, for example, can be performed by processing logic comprising hardware, software, firmware, or any combination thereof of the RL system 100. Such processing logic can include an agent circuit 104 that performs RL tuning of values that track one or more states associated with learning from an environment 106. The environment 106 can include, for example, a digital twin server and/or a storage performance development kit (SPDK) that may be executable by a server and is capable of providing a state (sₜ) and a reward (rₜ) in response to changes in the environment that are based on an action (aₜ) caused by the agent circuit 104.

More specifically, at each time step, the agent circuit 104 observes the state (sₜ) of the environment 106 and causes an action (aₜ) to be performed. Upon performing the action, the environment 106 sends a reward (rₜ), which can be understood as some feedback from the environment 106. Although this feedback may be called a reward, if the reward value is negative, it can be understood to serve as a penalty. This process of observing, performing an action, and triggering a reward continues in an iterative fashion to maximize the cumulative reward. The RL system 100 thus is capable of performing a fine-tuning of the RL routine (also referred to as training) as well as carrying out an action (e.g., reward/penalty) in each iteration of the RL routine, also referred to as inferencing because the action triggers the ability to observe a new state and act on a new reward. In some cases, the learning/modeling and inferencing can be performed via simulation, SPDK, and within a firmware-like software environment. This software-like environment, as discussed, adds latencies to interface with any hardware and delays updates in congestion-related configurations.

Reinforcement learning (RL) algorithms or routines generally come in two different types, a model-based RL and a model-free RL. In model-based RL, the RL system 100 uses both a transition function and the reward function in order to estimate an optimal policy or set of parameters. Here, the agent circuit 104 is planning ahead. Model-free RL estimates a policy directly by interacting with the environment. One needs to interact with the environment to get rewards associated with the action. So there is no need to store any information about the model.

Of particular focus in this disclosure is a temporal difference (TD) algorithm that may be employed as the RL routine. The temporal difference can be a way of comparing temporally successive predictions. TD-related methods can learn directly from episodes of experience. TD-related routines are model-free, so they do not keep reference knowledge of Markov Decision Process (MDP) transitions and reward functions. Instead of calculating the total future reward, TD methods attempt to predict the combination of immediate reward and a reward prediction at the next moment in time. One example of a TD algorithm or routine is in Equation (1).

V(sₜ)=V(sₜ)+α*(rₜ+1+γ*V(sₜ+1)−V(sₜ)) (1)

Based on reward received, estimates a value function (V) for a given state (s) at time (t) following applied policy. This may be understood as a simple one-step TD update. This bootstrapping guess update continues to get better predictions. In Equation (1), a learning rate (α) is a constant that causes the value function to determine to what extent newly acquired information overrides old information. Further, a discount factor (γ) causes the value function to determine the importance of future rewards. Additionally, a reward (r) is what the environment provides to the value function.

In various instances, there are two variations in this TD learning: on-policy and off-policy. A policy can be applied by the agent circuit 104 for the next action based on the current state. For an on-policy routine (or function), the agent circuit 104 selects the action for each state while learning a policy, of which State-Action-Reward-State-Action (SARSA) is an example. For an off-policy routine (or function), the agent circuit 104 uses a defined policy for choosing an action for a state, of which Q-learning is an example.

By way of example of an on-policy routine, SARSA may be expressed according to Equation (2).

Q(sₜ,aₜ)=Q(sₜ,aₜ)+α*(rₜ+γ*Q(sₜ₊₁,aₜ₊₁)−Q(sₜ,aₜ)) (2)

In Equation (2), the Q-value represents a quality of an action for a given state, where sₜ is a current state, sₜ₊₁ is a next state, aₜ is a current action chosen using the policy, aₜ₊₁ is a next action using a current Q-value, rₜ is a current reward from the environment 106, α is a learning rate, and γ is a discount factor for a next reward.

For the SARSA routine, the agent circuit 104 interacts with the environment and updates the policy based on actions taken. The Q-value for a state-action is updated by an error, which is adjusted by the learning rate. Q-values represent the possible reward received in the next time step for taking action in state, plus the discounted future reward received from the next state-action observation. SARSA creates a Q-table, which is used to arrive at an optimal policy. In order to learn that policy, the agent circuit 104 explores the environment 106.

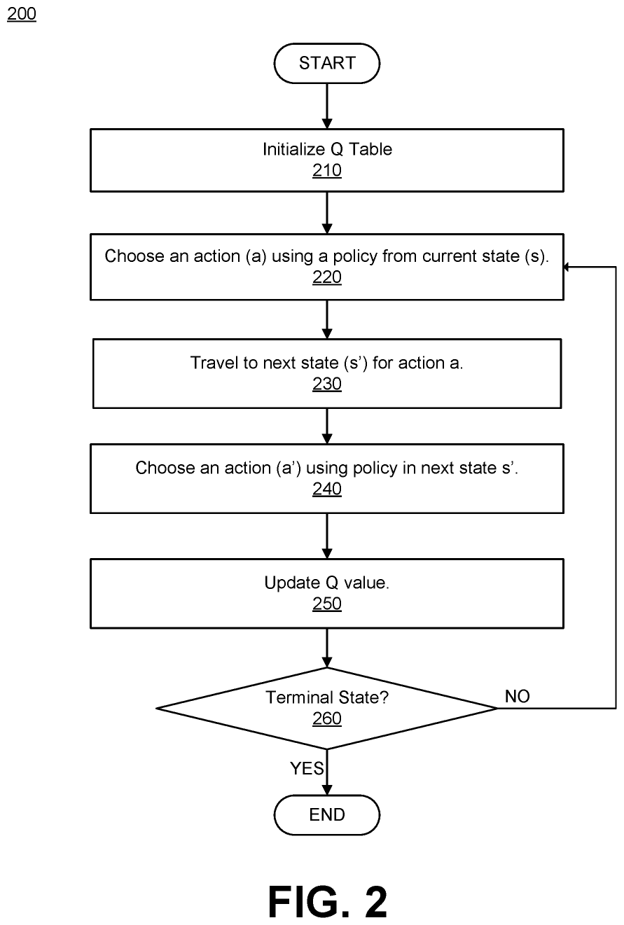

FIG. 2 is a flow diagram of a SARSA algorithm 200, an example of a type of RL, in accordance with at least some embodiments. The SARSA algorithm 200 can be performed by processing logic comprising hardware, software, firmware, or any combination thereof of the RL system 100.

At operation 210, the processing logic initializes a Q table, which can be used to correlate state values to a subsequent action and be iteratively updated as the SARSA algorithm 200 learns from the inferences of the environment 106.

At operation 220, the processing logic chooses an action (a) using a policy from the current state (s) derived from the Q table.

At operation 230, the processing logic travels to a next state (s′) for the action (a).

At operation 240, the processing logic chooses a next action (a′) using the policy in the next state (s′).

At operation 250, the processing logic updates the Q value in the Q table according to Equation (2).

At operation 260, the processing logic determines whether the next state (s′) matches a terminal (or target) state. If the next state matches the terminal state, the SARSA algorithm 200 completes, as the environment 106 has been optimized. Otherwise, if the next state does not match the terminal state, the SARSA algorithm 200 loops back to operation 220 and continues iteratively performing the SARSA algorithm.

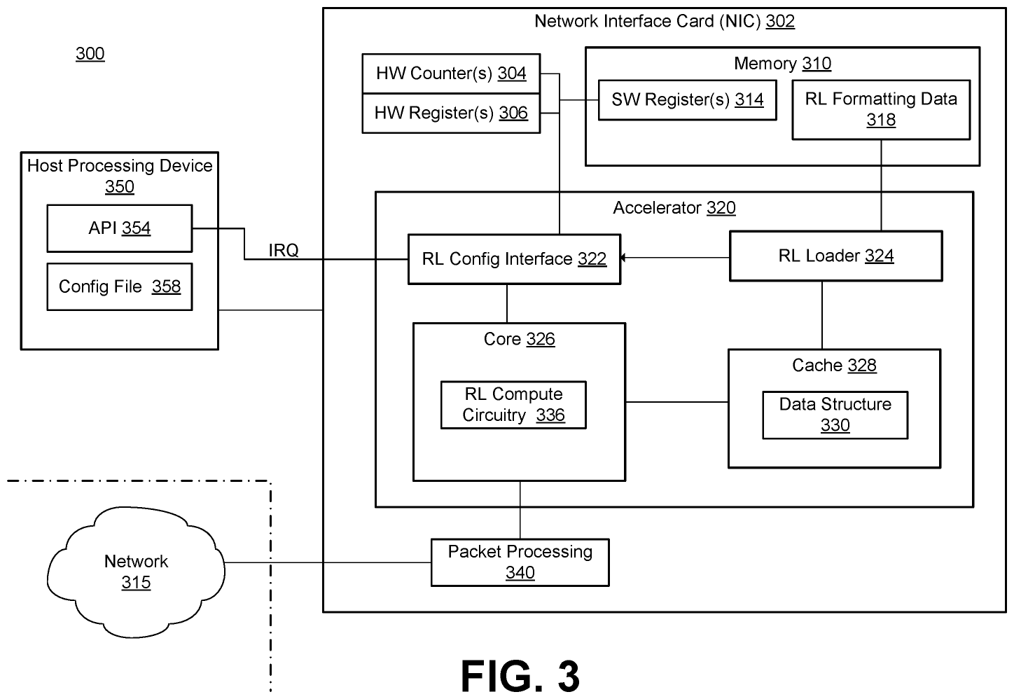

FIG. 3 is a block diagram of a network device 300 containing a network interface card (NIC) 302 to which is offloaded reinforcement learning, in accordance with at least some embodiments. In various embodiments, the network device 300 further includes a host processing device 350 coupled to the NIC 302, and the NIC 302 could also be a similar integrated network interface device or system. In at least some embodiments, the host processing device 350 includes an application processing interface (API) 354, such as software for interfacing with the NIC 302, and creates a configuration file 358, as will be discussed.

In at least some embodiments, the host processing device 350 is a CPU or an APU, for example. In other embodiments, the network device 300 is a smart NIC such as the NVIDIA® BlueField® data processing unit (DPU), or graphics processing units (GPUs), that offload critical network, security, and storage tasks from another CPU, for example, by supporting remote direct memory access (RDMA) operations and directly reading or writing to attached storage devices in response to remote initiator requests.

In at least some embodiments, the NIC 302 includes a set of hardware (HW) counters 304, a set of HW registers 306, a memory 310, an accelerator circuit 320 (or accelerator circuitry), and packet processing circuitry 340 (or other network interface) to receive network packets over a network 315. The memory 310 (such as dynamic random access (DRAM) memory or other volatile memory) can include a set of software registers 314 (e.g., SW registers 314) and RL formatting data 318. In some embodiments, the memory 310 includes one or more of the SW registers 314 to store configuration values, which will be discussed, and a range of memory addresses allocated to storing formatting data for the RL routine, as will also be discussed. In at least one embodiment, the accelerator circuit 320 is a serverless application model (SAM) accelerator, an intelligence processing unit (IPU), a neural network processor (NNP), a graphics processing unit (GPU), a field programmable gate array (FPGA), an application-specific integrated circuitry (ASIC), or a hardware-specific programmed processing circuit, for example.

In at least some embodiments, the accelerator circuit 320 can include an RL configuration interface 322 that interfaces with the host processing device 350, an RL loader 324, a core 326 (that acts as an agent circuit) having RL compute circuitry 336, and a cache 328 to store a data structure 330. In some embodiments, the cache 328 is static random access memory (SRAM), tightly-coupled memory (TCM), or other on-chip cache providing fast access to data stored on the cache 328.

In these embodiments, the host processing device 350 executes the API 354 in order to interface with the NIC 302, and in particular, to cause the accelerator circuit 320 to program the NIC 302 to be configured to run the RL application, e.g., initialization of the RL application. For example, the API 354 can send an interrupt request (IRQ) to the NIC 302 to cause a context switch of the accelerator circuit 320 to an application associated with the RL routine. The API 354 can further send a configuration file to the NIC 302. The NIC 302 can deploy the configuration file such as to cause the accelerator circuit 320 (e.g., the RL configuration interface 322) to program the configuration values and associated formatting data into the memory and registers. Once configured, the accelerator circuit 320 can further detect that a configuration value that has been updated due to work of the RL routine and provide event signals (e.g., IRQ) back to the API 354 indicating that the configuration value has been updated, a final inference made, or the RL routine has otherwise reached an end state.

In various embodiments, the configuration values are associated with one or more RL-related parameters. In at least some embodiments, the configuration values include an iteration period of the RL routine, pointers to the HW counters 304, pointers to the HW registers 306, pointers to the SW registers 314, a reward function or other RL algorithm or routine, a valid actions list (if applicable), and specific algorithm fields. More particularly, the iteration period is how often to iterate through the RL routine if the RL routine is not triggered by network packets, for example. The HW counters 304 can be employed in order to increment or decrement a counter value corresponding to observations made in network traffic, e.g., associated bandwidth, throughput, congestion, and the like. Such observations can include that the network packet is received at a particular port or that it has a particular identifier, e.g., that may be located in a packet header, a packet trailer, or other predetermined portion of the network packet. Further, observations can also be made from values stored in the HW counters 304 or HW registers 306, which will be discussed in more detail. In some embodiments, a configuration value is a value corresponding to bandwidth, throughput, congestion, AI learning, or the like, of the network device 300. In some embodiments, a configuration value is or includes a hardware offset for a hardware counter of the set of hardware counters 304, e.g., which may be a starting place of observing or making inferences of the environment of the network device 300.

In at least some embodiments, the HW registers 306 may include control or state values that may be periodically updated to track a particular configuration value for an RL-related parameter of interest (e.g., bandwidth, throughput, congestion, AI-related value, or the like). The state values may also be understood to be inference values such as Q-values in the above-referenced SARSA routine. A pointer to a particular HW register can be retrieved from the configuration file in order to determine a target HW register or registers to which the state value(s) are stored. In at least one embodiment, updating a configuration value within the target HW register, within a similar SW register of the SW registers 314, or within the data structure 330 can be understood as causing an action to be performed so that the RL routine can perform further learning based on inferences made within the environment.

In at least some embodiments, the valid actions list is stored in the data structure 330, in which configuration value updates correspond to a particular value range for the cumulative state value based on an RL algorithm or routine. The valid actions list may be employed with some RL routines but not others. Those that use a valid actions list can have certain predetermined rules, such as in a maze-like RL routine. Thus, the valid actions list could include up, down, right, left, and the like. Other RL routines that use inferences as a tuner to incrementally update the state values may not employ the valid actions list.

In these embodiments, the SW registers 314 are primarily meant as configuration registers to store configuration values related to the reward function or RL routine and can be memory mapped to the core 326 via the RL configuration interface 322. The RL compute circuitry 336 of the core 326 can thus access the values in the SW registers 314 to execute the RL routine. In some embodiments, the configuration values can include, but not be limited to, a policy configuration, a number of states, a number of actions, a learning rate, a discount factor, a number of episodes, and a type of temporal difference.

Further, in these embodiments, the RL loader 324 retrieves the RL formatting data 318 from the memory 310 and loads the RL formatting data 318 into the RL configuration interface 322 for access by the core 326. Further, the RL loader 324 can load the data structure 330 into the cache 328 from the RL formatting data 318 (or elsewhere in the memory 310), so that the values being learned within the data structure 330 can be retained between context switches, particularly when the RL goal (e.g., some target of a cumulative state value) has not yet been achieved by the accelerator circuit 320. Thus, the RL loader 324 can perform a context save-restore function with reference to the RL application running on the NIC 302.

In various embodiments, the packet processing circuitry 340 is configured to receive and parse network packets from other machines or packet sources over a network 315. The accelerator circuit 320, which is coupled to the packet processing circuitry 340, can then intercept, inspect, and otherwise detect particular packets associated with the RL application. For example, the accelerator circuit 320 (e.g., the RL compute circuitry 336) can detect a network packet received at a particular port or that includes a particular identifier. In some embodiments, the particular identifier is one of a destination address or a fixed byte portion of the network packet. The accelerator circuit 320 (e.g., the RL compute circuitry 336) can further execute the RL routine, using the configuration values and in response to detecting the network packet, to employ observation information derived from or associated with a network packet to perform an RL-related action.

In some embodiments, to execute the RL routine, the accelerator circuit 320 derives the observation information from the network packet, the observation information being associated with an RL-related parameter of the set of RL-related parameters. The accelerator circuit 320 can further update a hardware counter (e.g., of the HW counters 304) corresponding to the observation information. As just one example, the hardware counter can be associated with the bandwidth. As the bandwidth increases or decreases, the hardware counter is incremented or decremented, respectively; thus, the hardware counter incrementally tracks the changing bandwidth. The accelerator circuit 320 can further update, based on a value of the hardware counter, a cumulative state value stored in a hardware register (e.g., of the HW registers 306). Updates made to one or more of the HW registers 306 or one or more of the SW registers 314 can be understood as performing an action, e.g., by updating a cumulative state or control value associated with the RL-related parameter. These updates can then precipitate additional inferences made in subsequent RL routine iterations.

In these embodiments, the accelerator circuit 320 further updates, based on the cumulative state value in the hardware register, a configuration value for the RL-related parameter, which might be stored in the SW registers 314, for example. In some embodiments, the RL routine is a temporal difference (TD) algorithm that compares outcomes of temporally-successive predictions. The update to the configuration value includes a reward prediction.

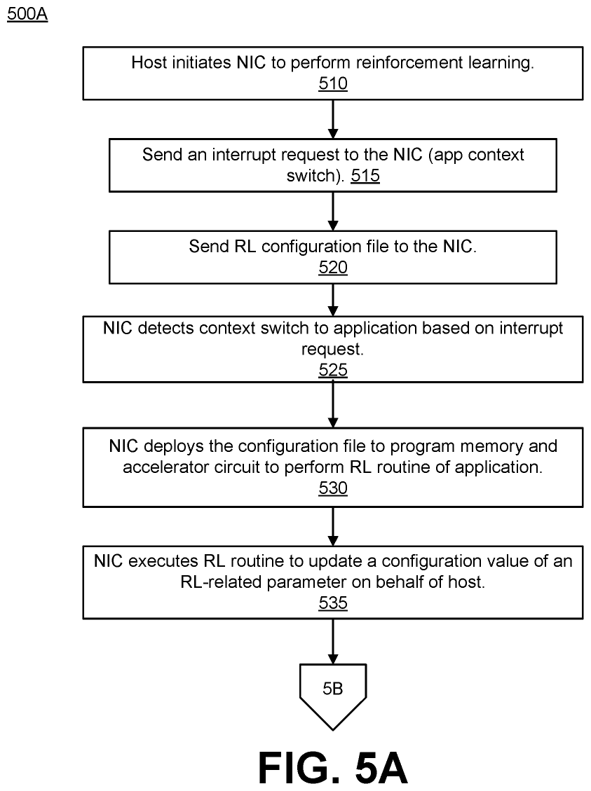

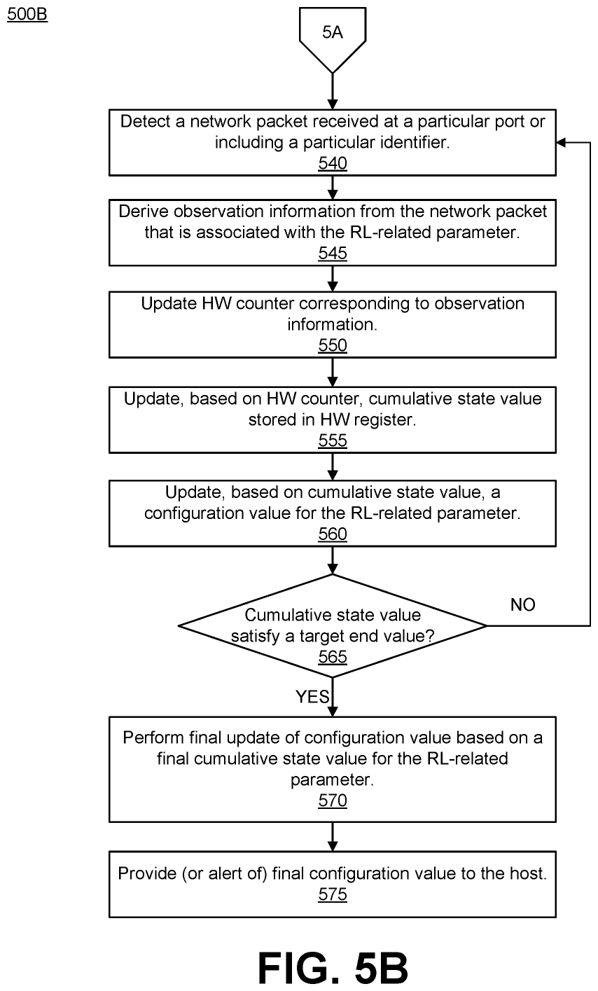

In at least some embodiments, the data structure 330 is loaded in the cache 328 (e.g., on-chip cache), e.g., by the RL loader 324 from the RL formatting data 318. The data structure 330 can include configuration value updates that correspond to a particular value range for the cumulative state value based on an RL algorithm. The accelerator circuit 320 (e.g., the RL compute circuitry 336) can then iteratively update the cumulative state value across iterations of the RL algorithm, and determine, from the data structure 330, a subsequent configuration value that corresponds to the updated cumulative state value. The accelerator circuit 320 can further update the configuration value to the subsequent configuration value for a subsequent iteration of the RL routine, for example, thus iteratively learning the environment associated with the network device 300 (see FIG. 5A).

In at least one embodiment, the accelerator circuit 320 is further to, in response to detecting the cumulative state value satisfy a target end value based on the algorithm that governs updates to the data structure 330, perform a final update of the configuration value associated with the RL-related parameter based on a final cumulative state value. The target end value can be, for example, associated with an optimal end state according to the algorithm used to update values within the data structure 330. The accelerator circuit 320 can then further trigger an interrupt event or request (e.g., IRQ) back to the API 354 indicating that the final configuration value is available and the iterations of the RL routine have been completed.

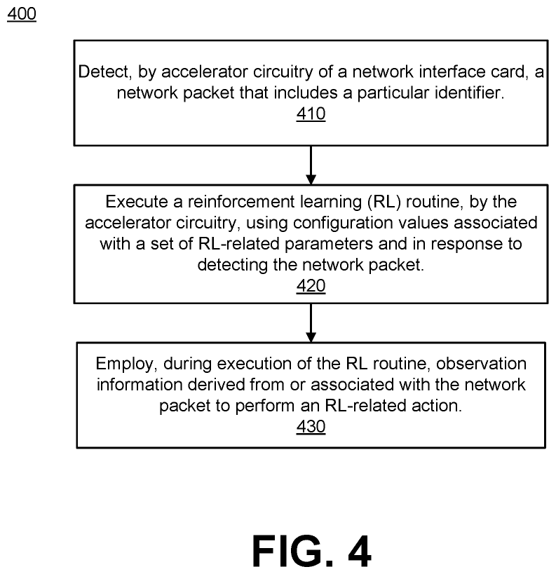

FIG. 4 is a flow diagram of method 400 performing reinforcement learning by a NIC, in accordance with at least some embodiments. The method 400 can be performed by processing logic comprising hardware, software, firmware, or any combination thereof. In at least one embodiment, the method 400 is performed by the NIC 302 of FIG. 3, and particularly by the accelerator circuit 320.

At operation 410, the processing logic detects a network packet that includes a particular criterion. The particular criterion can include, for example, that the network packet is received at a particular port or comprises a particular identifier or other identifying data or information.

At operation 420, the processing logic executes a reinforcement learning (RL) routine, using configuration values associated with a set of RL-related parameters and in response to detecting the network packet.

At operation 430, the processing logic employs, during execution of the RL routine, observation information derived from or associated with the network packet to perform an RL-related action.

FIG. 5A is a flow diagram of a method 500A for offloading reinforcement learning from a host processing device to a NIC, in accordance with at least some embodiments. The method 500A can be performed by processing logic comprising hardware, software, firmware, or any combination thereof. In at least one embodiment, the method 500 is performed by the network device 300 of FIG. 3, and in particular, in part by the host processing device 350 and in part by the NIC 302.

At operation 510, the processing logic (e.g., of the host processing device 350) initiates the NIC 302 to perform reinforcement learning (RL), which can include performing operations 515 and 520.

At operation 515, the processing logic sends an interrupt request to the NIC 302 to cause a context switch of the accelerator circuit to an application associated with the RL routine.

At operation 520, the processing logic sends a configuration file to the NIC 302, the configuration file to cause the accelerator circuit 320 to program the configuration values and associated formatting data into the memory 310.

At operation 525, the processing logic (e.g., of the NIC 302) detects a context switch to an application based on the interrupt request.

At operation 530, the processing logic deploys a configuration file received from the host processing device 350 to program the memory and the accelerator circuitry to perform reinforcement learning using the RL routine. In some embodiments, executing the configuration file causes the processing logic to load, into the memory 310, initial configuration values for the set of RL-related parameters and associated formatting data received from the host processing device. Executing the configuration file can further cause the processing logic to load, into the on-chip cache 328, the data structure 330 from the memory 310 that includes past cumulative state values and associated updates to the configuration values. Executing the configuration file can further cause the processing logic to identify an address that points to a hardware register of the HW registers 306, e.g., in which the cumulative state value will be updated (see FIG. 5B). These additional operations, among others, can be understood to effectuate a context switch into an RL application that has not yet been completed.

At operation 535, the NIC 302 executes the RL routine to update a configuration value of an RL-related parameter on behalf of the host processing device 350, as will be described in more detail with reference to FIG. 5B.

FIG. 5B is a flow diagram of a method 500B for the accelerator circuit 320 of the NIC 302 performing the RL routine or algorithm, in accordance with at least some embodiments. The method 500B can be performed by processing logic comprising hardware, software, firmware, or any combination thereof. In at least one embodiment, the method 500B is performed by the NIC 302 of FIG. 3, and particularly by the accelerator circuit 320.

At operation 540, the processing logic detects a network packet that is received at a particular port or that comprises a particular identifier.

At operation 545, the processing logic derives, from the network packet, observation information associated with the RL-related parameter of the set of RL-related parameters.

At operation 550, the processing logic updates a hardware counter corresponding to the observation information. The hardware counter can be one of the HW counters 304.

At operation 555, the processing logic updates, based on a value of the hardware counter, a cumulative state value stored in a hardware register. The hardware register can be one of the HW registers 306.

At operation 560, the processing logic updates a configuration value for the RL-related parameter based on the cumulative state value. For example, the cumulative state value may be stored in one of the SW registers 314.

At operation 565, the processing logic determines whether the cumulative state value satisfies a target end value, e.g., for which the RL algorithm is attempting to optimize. If the answer is no, the method 500B loops back to operation 540 to continue performing iterations of the RL routine with subsequently received network packets.

If the answer is yes at operation 565, then, at operation 570, the processing logic performs a final update of the configuration value based on a final cumulative state value for the RL-related parameter.

At operation 575, the processing logic provides the final updated configuration value to the host processing device 350. In another embodiment, the processing logic triggers an interrupt request to the host processing device 350 that indicates the final updated configuration value is available, e.g., in the SW registers 314, along with a pointer so that the API 354 can retrieve the final updated configuration value for the host processing device 350.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device, a NIC, or an accelerator. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A network interface device comprising:
a memory to store configuration values associated with a reinforcement learning (RL) routine and a set of RL-related parameters associated with the RL routine;
packet processing circuitry to receive network packets; and
accelerator circuitry coupled to the memory and the packet processing circuitry, the accelerator circuitry to:
detect a network packet that comprises a particular criterion; and
execute the RL routine, using the configuration values and in response to detecting the network packet, to employ observation information derived from or associated with the network packet to perform an RL-related action.

2. The network interface device of claim 1, wherein the particular criterion comprises being received at a particular port or containing a particular identifier, the particular identifier being one of a destination address or a fixed byte portion of the network packet.

3. The network interface device of claim 1, wherein, to execute the RL routine, the accelerator circuitry is further to:
derive the observation information from the network packet, the observation information being associated with an RL-related parameter of the set of RL-related parameters;
update a hardware counter corresponding to the observation information;
update, based on a value of the hardware counter, a cumulative state value stored in a hardware register; and
update, based on the cumulative state value, a configuration value for the RL-related parameter.

4. The network interface device of claim 3, wherein the RL routine comprises a temporal difference (TD) algorithm that is to compare outcomes of temporally-successive predictions, and wherein the update to the configuration value includes a reward prediction.

5. The network interface device of claim 3, further comprising an on-chip cache to store a data structure in which configuration value updates correspond to a particular value range for the cumulative state value based on an RL algorithm, wherein the accelerator circuitry is further to:
iteratively update the cumulative state value across iterations of the RL algorithm;
determine, from the data structure, a subsequent configuration value that corresponds to the updated cumulative state value; and
further update the configuration value to the subsequent configuration value for a subsequent iteration of the RL routine.

6. The network interface device of claim 5, wherein the accelerator circuitry is further to, in response to detecting the cumulative state value satisfying a target end value based on the algorithm that governs updates to the data structure, perform a final update of the configuration value associated with the RL-related parameter based on a final cumulative state value.

7. The network interface device of claim 3, further comprising the hardware counter and the hardware register coupled with the accelerator circuitry, and wherein the memory comprises:
one or more software registers to store the configuration values; and
a range of memory addresses allocated to storing formatting data for the RL routine.

8. The network interface device of claim 3, further comprising an on-chip cache to store a data structure in which configuration value updates correspond to a particular value range for the cumulative state value, wherein the accelerator circuitry is coupled with a host processing device, the accelerator circuitry further to:
detect, based on an interrupt request received from the host processing device, a context switch to an application associated with the RL-related parameter; and
deploy a configuration file received from the host processing device to program the memory and the accelerator circuitry to perform reinforcement learning using the RL routine, wherein to deploy the configuration file, the accelerator circuitry is further to:
load, into the memory, initial configuration values for the set of RL-related parameters and associated formatting data received from the host processing device; and
load, into the on-chip cache, the data structure from the memory that includes past cumulative state values and associated updates to the configuration values.

9. A data processing unit comprising:
a network interface card (NIC) comprising:
a memory to store configuration values associated with a reinforcement learning (RL) routine and a set of RL-related parameters for implementing the RL routine;
a network interface to receive network packets; and
an accelerator circuit coupled to the memory and the network interface, the accelerator circuit to iteratively:
detect a network packet that comprises a particular criterion; and
execute the RL routine, using the configuration values and in response to detecting the network packet, to employ observation information derived from or associated with a network packet to perform an RL-related action; and
a host processing device coupled with the NIC, the host processing device to:
send an interrupt request to the NIC to cause a context switch of the accelerator circuit to an application associated with the RL routine; and
send a configuration file to the NIC, the configuration file to cause the accelerator circuit to program the configuration values and associated formatting data into the memory.

10. The data processing unit of claim 9, wherein the memory comprises:
one or more software registers to store the configuration values; and
a range of memory addresses allocated to storing formatting data for the RL routine.

11. The data processing unit of claim 9, wherein the particular criterion comprises being received at a particular port or containing a particular identifier, the particular identifier being one of a destination address or a fixed byte portion of the network packet.

12. The data processing unit of claim 9, wherein the NIC further comprises:
a hardware counter coupled with the accelerator circuit; and
a hardware register coupled with the accelerator circuit; and
wherein, to execute the RL routine, the accelerator circuit is further to:
derive the observation information from the network packet, the observation information being associated with an RL-related parameter of the set of RL-related parameters;
update the hardware counter corresponding to the observation information;
update, based on a value of the hardware counter, a cumulative state value stored in the hardware register; and
update, based on the cumulative state value, a configuration value for the RL-related parameter.

13. The data processing unit of claim 12, wherein, to execute the RL routine, the accelerator circuit is to perform a temporal difference (TD) algorithm by comparing outcomes of temporally-successive predictions, and wherein the update to the configuration value includes a reward prediction.

14. The data processing unit of claim 12, wherein the NIC further comprises an on-chip cache to store a data structure in which configuration value updates correspond to a particular value range for the cumulative state value based on an RL algorithm, wherein the accelerator circuit is further to:
iteratively update the cumulative state value across iterations of the RL algorithm;
determine, from the data structure, a subsequent configuration value that corresponds to the updated cumulative state value; and
further update the configuration value to the subsequent configuration value for a subsequent iteration of the RL routine.

15. The data processing unit of claim 14, wherein the accelerator circuit is further to, in response to detecting the cumulative state value satisfying a target based on the algorithm that governs updates to the data structure, perform a final update of the configuration value associated with the RL-related parameter based on a final cumulative state value.

16. The data processing unit of claim 12, wherein the NIC further comprises an on-chip cache to store a data structure in which configuration value updates correspond to a particular value range for the cumulative state value, wherein the accelerator circuit is further to:
detect, based on the interrupt request received from the host processing device, a context switch to the application; and
deploy the configuration file received from the host processing device to program the memory and the accelerator circuit to perform reinforcement learning using the RL routine, wherein to deploy the configuration file, the accelerator circuit is further to:
load, into the memory, initial configuration values for the set of RL-related parameters and associated formatting data received from the host processing device;
load, into the on-chip cache, the data structure from the memory that includes past cumulative state values and associated updates to the configuration values; and
identify an address that points to the hardware register.

17. A method comprising:
detecting, by accelerator circuitry of a network interface device, a network packet that comprises a particular criterion; and
executing a reinforcement learning (RL) routine, by the accelerator circuitry, using configuration values associated with a set of RL-related parameters and in response to detecting the network packet, and
wherein executing the RL routine comprises employing observation information derived from or associated with the network packet to perform an RL-related action.

18. The method of claim 17, wherein the particular criterion comprises being received at a particular port or containing a particular identifier, the particular identifier being one of a destination address or a fixed byte portion of the network packet.

19. The method of claim 17, wherein executing the RL routine further comprises:
deriving the observation information from the network packet, the observation information being associated with an RL-related parameter;
updating a hardware counter corresponding to the observation information;
updating, based on a value of the hardware counter, a cumulative state value stored in a hardware register; and
updating, based on the cumulative state value, a configuration value for the RL-related parameter.

20. The method of claim 19, wherein the RL routine comprises a temporal difference (TD) algorithm that is to compare outcomes of temporally-successive predictions, and wherein the update to the configuration value includes a reward prediction.

21. The method of claim 19, further comprising:
storing, within on-chip cache of the network interface device, a data structure in which configuration value updates correspond to a particular value range for the cumulative state value;
iteratively updating the cumulative state value across iterations of the RL routine;
determining, from the data structure, a subsequent configuration value that corresponds to the updated cumulative state value; and
further updating the configuration value to the subsequent configuration value for a subsequent iteration of the RL routine

22. The method of claim 19, further comprising:
storing, within on-chip cache of the network interface device, a data structure in which configuration value updates correspond to a particular value range for the cumulative state value;
detecting, based on an interrupt request received from a host processing device, a context switch to an application associated with the RL-related parameter; and
executing a configuration file received from the host processing device to program a memory and the accelerator circuitry to perform reinforcement learning using the RL routine, wherein to deploy the configuration file, the method further comprising:
loading, into the memory, initial configuration values for the set of RL-related parameters and associated formatting data received from the host processing device; and
loading, into the on-chip cache, the data structure from the memory that includes past cumulative state values and associated updates to the configuration values.
